(19) United States
(12) Patent Application Publication
(10) Pub. No.: US 2012/0155311 A1
(43) Pub. Date: Jun. 21, 2012

(54) APPARATUS AND METHOD FOR DETERMINING POSITION OF TARGET OBJECT IN WLAN ENVIRONMENT

(75) Inventors: Seung-Chan BANG, Daejeon (KR); Young-Hoon KIM, Daejeon (KR); Ki-Chul HAN, Daejeon (KR); Don-Sung OH, Daejeon (KR); II-Gyu KIM, Okcheon-gun (KR)

(73) Assignee: Electronics and Telecommunications Research Institute, Daejeon (KR)

(21) Appl. No.: 13/333,714

(22) Filed: Dec. 21, 2011

(30) Foreign Application Priority Data
Dec. 21, 2010 (KR) 10-2010-0131574

(51) Int. Cl. H04W 24/00

(52) U.S. Cl. 370/252

(57) ABSTRACT

An apparatus and method for determining the position of a target object in a wireless local area network (WLAN) environment are provided. According to the apparatus and method, it is possible for a user to easily identify each neighboring target object and to precisely select any desired neighboring target object. Therefore, it is possible to improve user convenience.

### CROSS-REFERENCE TO RELATED APPLICATION(S)

This application claims the benefit under 35 U.S.C. §119(a) of Korean Patent Application No. 10-2010-0131574, filed on Dec. 21, 2010, in the Korean Intellectual Property Office, the entire disclosure of which is incorporated herein by reference for all purposes.

### BACKGROUND

1. Field

The following description relates to a technique of determining the position of a target object, and more particularly, to an apparatus and method for determining the position of a target object in a wireless local area network (WLAN) environment.

2. Description of the Related Art

In a wireless local area network (WLAN) environment such as, for example, Bluetooth, terminals may be represented simply by their names, and thus may not be precisely identified or selected unless their exact names are known.

More specifically, in a case in which there is only one neighboring terminal that communicates with a predetermined terminal in a WLAN environment, a user of the predetermined terminal may not have difficulty choosing a terminal to communicate with. However, if there are multiple neighboring terminals in the WLAN environment, it is necessary to properly represent the neighboring terminals and thus to help the user of the predetermined terminal to easily identify and select a desired terminal from among the neighboring terminals.

### SUMMARY

The following description relates to a technique of determining the position of a target object in a wireless local area network (WLAN) environment in which multiple terminals exist so that a user may easily identify the target object from among the multiple terminals.

The following description also relates to a technique of determining the position of a target object in a WLAN environment in which multiple terminals exist so that a user may easily select the target object from among the multiple terminals.

In one general aspect, there is provided an apparatus for determining the position of a target object in a wireless local area network (WLAN) environment, including: a direction determination unit configured to determine directions of one or more neighboring target objects based on one or more wireless signals that are transmitted by the neighboring target objects; a is distance determination unit configured to determine distances of the neighboring target objects based on the wireless signals; and a target position display unit configured to display position information of the neighboring target objects, including the determined directions and the determined distances.

The apparatus may further include a target object selection unit configured to select one of the neighboring target objects in response to user manipulation.

The apparatus may further include a communication unit configured to communicate with the selected neighboring target object.

The direction determination unit may include an arrival angle estimation module configured to estimate angles of arrival of the wireless signals and a direction determination module configured to determine directions of the neighboring target objects based on the estimated arrival angles.

The distance determination unit may include a signal intensity measurement module configured to measure intensities of the wireless signals and a distance determination module configured to determine the distances of the neighboring target objects based on the measured wireless signal intensities.

The target position display unit may be further configured to qualitatively display the position information of the neighboring target objects.

The target position display unit may be further configured to qualitatively display the position information of the neighboring target objects by using arrows to represent the directions of the neighboring target objects and using bars of various lengths to represent the distances of the neighboring target objects.

The target position display unit may be further configured to display identification information of the neighboring target objects.

In another general aspect, there is provided a method of determining the position of a target object in a WLAN environment, including: receiving one or more wireless signals from one or more neighboring target objects in a WLAN environment; determining directions and distances of the neighboring target objects by analyzing the wireless signals; and displaying position information of the neighboring target objects, including the determined directions and the determined distances.

Other features and aspects may be apparent from the following detailed description, the drawings, and the claims.

### BRIEF DESCRIPTION OF THE DRAWINGS

FIG. 1 is a diagram illustrating an example of an apparatus for determining the position of a target object in a wireless local area network (WLAN) environment.

FIG. 2 is a diagram illustrating an example of a direction determination unit illustrated in FIG. 1.

FIG. 3 is a diagram illustrating an example of a distance determination unit illustrated in FIG. 1.

FIG. 4 is a diagram illustrating an example of qualitatively representing the position of a target object.

FIG. 5 is a flowchart illustrating an example of a method of determining the position of a target object in a WLAN environment.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

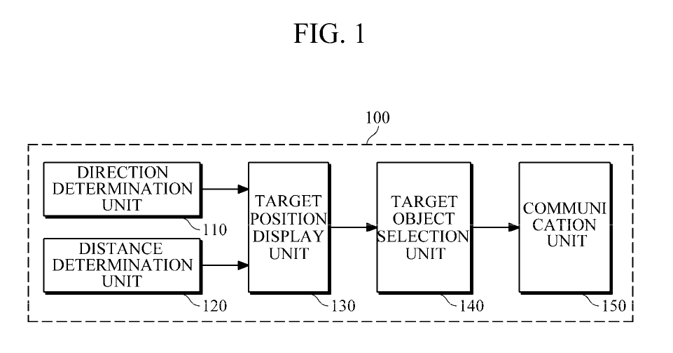

FIG. 1 illustrates an example of an apparatus for determining the position of a target object in a wireless local area network (WLAN) environment. Referring to FIG. 1, apparatus 100 includes a direction determination unit 110, a distance determination unit 120, and a target position display unit 130.

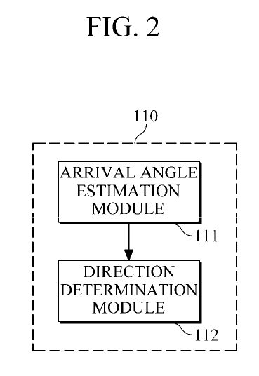

The direction determination unit 110 may determine the directions of one or more neighboring target objects based on one or more wireless signals that are transmitted by the neighboring target objects. For example, the direction determination unit 110 may determine the directions of the neighboring target objects based on the angles of arrival of the wireless signals, which is further described with reference to FIG. 2.

FIG. 2 illustrates an example of the direction determination unit 110. Referring to FIG. 2, the direction determination unit 110 includes an arrival angle estimation module 111 and a direction determination module 112.

The arrival angle estimation module 111 may estimate the angles of arrival of the wireless signals transmitted by the neighboring target objects. For example, the arrival angle estimation module 111 may estimate the angles of arrival of one or more wireless signals that are received via each antenna in an array of antennas based on the inherent structural properties of a is covariance matrix that is obtained based on the wireless signals. In another example, the arrival angle estimation module 111 may estimate the angle of arrival of a wireless signal using a maximum likelihood estimation (MLE) method, a multiple signal classification (MUSIC) algorithm, or a sub-space rotation invariant principle-based estimation method. The MLE method, the MUSIC algorithm, and the sub-space rotation invariant principle-based estimation method, which are based on the assumption that the source of the wireless signal is a spot signal, are well-known to one of ordinary skill in the art to which the present invention pertains, and thus, detailed descriptions thereof will be omitted.

The direction determination module 112 may determine the directions of the neighboring target objects based on arrival angle estimates provided by the arrival angle estimation module 111. The angle of arrival of a wireless signal is the angle at which radio waves are incident upon an antenna. In response to the angles of arrival of the wireless signals transmitted by the neighboring target objects being determined by the arrival angle estimation module 111, the direction determination module 112 may determine the directions of the neighboring target objects.

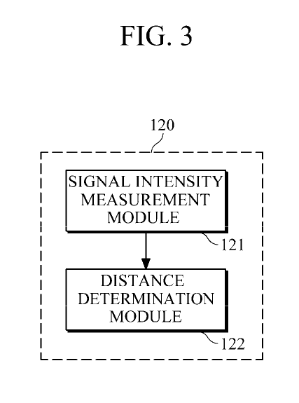

The distance determination unit 120 may determine the distances of the neighboring target objects based on the wireless signals transmitted by the neighboring target objects. For example, the distance determination unit 120 may determine the distances of the neighboring target objects by measuring the intensities of the wireless signals transmitted by the neighboring target objects, which is further described with reference to FIG. 3.

FIG. 3 illustrates an example of the distance determination unit 120. Referring to FIG. 3, the distance determination unit 120 includes a signal intensity measurement module 121 and a distance determination module 122.

The signal intensity measurement module 121 may measure the intensities of the wireless is signals transmitted by the neighboring target objects. For example, the signal intensity measurement module 121 may measure the received signal strength indication (RSSI) levels of the wireless signals transmitted by the neighboring target objects.

The distance determination module 122 may determine the distances of the neighboring target objects based on wireless signal intensity measurements provided by the signal intensity measurement module 121. For example, in response to measured RSSI levels being provided by the signal intensity measurement module 121, the distance determination unit 122 may determine the relative distances of the neighboring target objects based on the measured RSSI levels.

The target position display unit 130 may display position information of the neighboring target objects based on direction information provided by the direction determination unit 110 and distance information provided by the direction determination unit 120. The target position display unit 130 may also display identification information of the neighboring target objects. For example, the identification information may include representative names of the neighboring target objects.

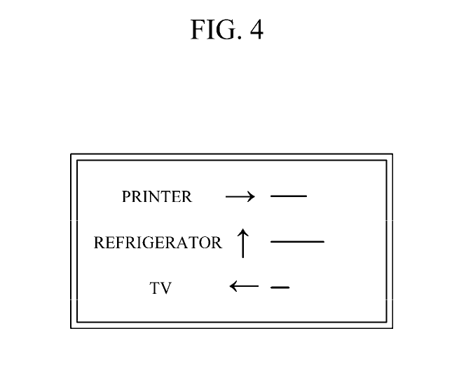

For example, the target position display unit 130 may qualitatively display the position information of the neighboring target objects, which is further described with reference to FIG. 4.

FIG. 4 illustrates an example of qualitatively representing the position of a target object. Referring to FIG. 4, the target position display unit 130 may qualitatively display the positions of one or more target objects by using arrows to represent the directions of the target objects and using bars of various lengths to represent the distances of the target objects.

A peripheral device (hereinafter referred to as the printer) with a representative name ‘Printer’ may be located on the right side of the apparatus 100, may be closer than a peripheral is device (hereinafter referred to as the refrigerator) with a representative name ‘Refrigerator’ to the apparatus 100, and may be more distant than a peripheral device (hereinafter referred to as the TV) with a representative name ‘TV’ to the apparatus 100. The refrigerator may be located at the front of the apparatus 100, and may be more distant than the printer and the TV to the apparatus 100. The TV may be located on the left side of the apparatus 100, and may be closer than the printer and the TV to the apparatus 100.

Since the apparatus 100 qualitatively displays the position of each neighboring object in a WLAN environment, it is possible for a user to easily identify each neighboring object regardless of how many objects there are near the apparatus 100.

Referring to FIG. 1, the apparatus 100 may also include a target object selection unit 140. The target object selection unit 140 may select a target object from among one or more target objects whose position information is provided by the target position display unit 130.

For example, a user interface may be provided by the target object selection unit 140 so that a user may select a target object from among one or more target objects whose position information is provided by the target position display unit 130 using the user interface. Accordingly, it is possible for the user to easily and precisely select any desired target object from among a plurality of target objects in a WLAN environment.

The apparatus 100 may also include a communication unit 150. The communication unit 150 may communicate with the target object selected by the target object selection unit 140. For example, in response to a target object being selected from among one or more neighboring target objects in a WLAN environment by the target object selection unit 140, the apparatus 100 may communicate with the selected target object via the communication unit 150.

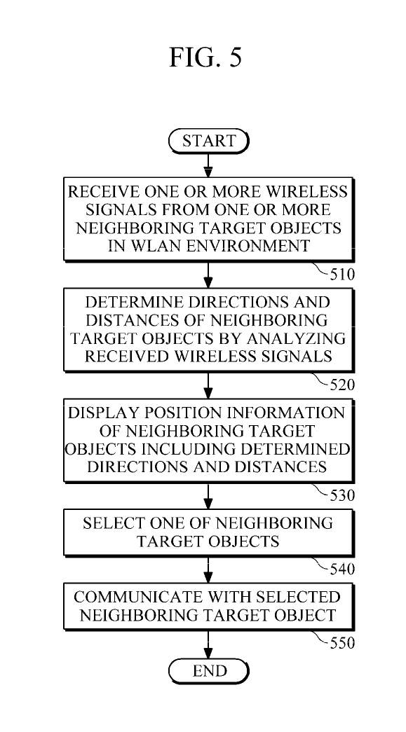

FIG. 5 illustrates an example of a method of determining the position of a target object in is a WLAN environment. Referring to FIG. 5, in 510, an apparatus for determining the position of a target object in a WLAN environment may receive one or more wireless signals from one or more neighboring target object in a WLAN environment. For example, the apparatus may receive the wireless signals via an array of antennas.

In 520, the apparatus may determine the directions and the distances of the neighboring target objects by analyzing the wireless signals. For example, as described above with reference to FIG. 2, the apparatus may estimate the angles of arrival of the wireless signals, and may determine the directions of the neighboring target objects. For example, as described above with reference to FIG. 3, the apparatus may measure the intensities of the wireless signals, and may determine the distances of the neighboring target objects.

In 530, the apparatus may display the positions of the neighboring target objects based on the directions and distances determined in 520. The apparatus may also display identification information of the neighboring target objects. For example, the identification information may be representative names of the neighboring target objects. The apparatus may qualitatively display the positions of the neighboring target objects. For example, as described above with reference to FIG. 4, the apparatus may qualitatively display the positions of the neighboring target objects by using arrows to represent the directions of the neighboring target objects and using bars of various lengths to represent the distances of the neighboring target objects.

Therefore, it is possible for a user to easily identify each of the neighboring target objects.

In 540, the apparatus may select one of the neighboring target objects. For example, in response to user manipulation, the apparatus may select one of the neighboring target objects.

Therefore, it is possible for a user to precisely select any desired target object from among the neighboring target objects.

In 550, the apparatus may communicate with the target object selected in 540.

As described above, it is possible to determine the directions of and the distances of one or more neighboring target objects in a WLAN environment based on one or more wireless signals that are transmitted by the neighboring target objects, and to display position information of the neighboring target objects based on the results of the determination. Therefore, it is possible for a user to easily identify each of the neighboring target objects.

In addition, it is possible for the user to easily and precisely select any desired target object from among the neighboring target objects. Therefore, it is possible to improve user convenience.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-is readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for determining the position of a target object in a wireless local area network (WLAN) environment, comprising:
a direction determination unit configured to determine directions of one or more neighboring target objects based on one or more wireless signals that are transmitted by the neighboring target objects;
a distance determination unit configured to determine distances of the neighboring target objects based on the wireless signals; and
a target position display unit configured to display position information of the neighboring target objects, including the determined directions and the determined distances.

2. The apparatus of claim 1, further comprising:
a target object selection unit configured to select one of the neighboring target objects in is response to user manipulation.

3. The apparatus of claim 2, further comprising:
a communication unit configured to communicate with the selected neighboring target object.

4. The apparatus of claim 1, wherein the direction determination unit comprises:
an arrival angle estimation module configured to estimate angles of arrival of the wireless signals; and
a direction determination module configured to determine directions of the neighboring target objects based on the estimated arrival angles.

5. The apparatus of claim 1, wherein the distance determination unit comprises:
a signal intensity measurement module configured to measure intensities of the wireless signals; and
a distance determination module configured to determine the distances of the neighboring target objects based on the measured wireless signal intensities.

6. The apparatus of claim 1, wherein the target position display unit is further configured to qualitatively display the position information of the neighboring target objects.

7. The apparatus of claim 6, wherein the target position display unit is further configured to qualitatively display the position information of the neighboring target objects by using arrows is to represent the directions of the neighboring target objects and using bars of various lengths to represent the distances of the neighboring target objects.

8. The apparatus of claim 1, wherein the target position display unit is further configured to display identification information of the neighboring target objects.

9. A method of determining the position of a target object in a WLAN environment, comprising:
receiving one or more wireless signals from one or more neighboring target objects in a WLAN environment;
determining directions and distances of the neighboring target objects by analyzing the wireless signals; and
displaying position information of the neighboring target objects, including the determined directions and the determined distances.

10. The method of claim 9, further comprising:
selecting one of the neighboring target objects in response to user manipulation.

11. The method of claim 10, further comprising:
communicating with the selected neighboring target object.

12. The method of claim 9, wherein the analyzing the wireless signals comprises:
estimating angles of arrival of the wireless signals; and
determining directions of the neighboring target objects based on the estimated arrival is angles.

13. The method of claim 9, wherein the analyzing the wireless signals comprises:
measuring intensities of the wireless signals; and
determining the distances of the neighboring target objects based on the measured wireless signal intensities.

14. The method of claim 9, wherein the displaying the position information of the neighboring target objects comprises qualitatively displaying the position information of the neighboring target objects.

15. The method of claim 14, wherein the displaying the position information of the neighboring target objects further comprises qualitatively displaying the position information of the neighboring target objects by using arrows to represent the directions of the neighboring target objects and using bars of various lengths to represent the distances of the neighboring target objects.

16. The method of claim 9, wherein the displaying the position information of the neighboring target objects comprises displaying identification information of the neighboring target objects.
